(19) United States
(12) Patent Application Publication
(10) Pub. No.: US 2011/0053016 A1
(43) Pub. Date: Mar. 3, 2011

(54) Method for Manufacturing and Distributing Hydrogen Storage Compositions

(76) Inventors: Daniel Braithwaite, San Francisco, CA (US); Tibor Fabian, San Francisco, CA (US); Richard Martin, San Francisco, CA (US)

(21) Appl. No.: 12/868,640

(22) Filed: Aug. 25, 2010

Related U.S. Application Data
(60) Provisional application No. 61/236,857, filed on Aug. 25, 2009.

(51) Int. Cl. H01M 8/06

(52) U.S. Cl. 429/416; 429/427

(57) ABSTRACT

The method of generating and delivering on-demand power to the consumer in a low-carbon-emitting manner comprises the steps of: generating energy from a low-carbon-emitting source, using the generated energy to generate a hydrogen storage composition, transporting the hydrogen storage composition and a reagent to the consumer, facilitating the use of the hydrogen storage composition to generate electricity, and facilitating the return of the by-products to a regeneration facility. This method is preferably used to distribute an on-demand power source to the consumer. One potential advantage of this distribution method includes low carbon emissions. By leveraging low-emission energy sources, utilizing low-emission distribution channels, and placing the energy source (H₂) and energy generation (conversion of H₂ to electricity) in the consumer's hands, unexpected savings in environmental impact, as measured by carbon emission, can be achieved.

### CROSS-REFERENCE TO RELATED APPLICATIONS

This application claims the benefit of U.S. Provisional Application No. 61/236,857, filed 25 Aug. 2009 and entitled “Methods and Systems for Manufacturing Hydrogen Storage Compositions with Renewable Energy”, which is incorporated in its entirety by this reference.

### TECHNICAL FIELD

This invention relates generally to the consumer products field, and more specifically to a low-carbon emitting method of delivering on-demand power to the consumer.

### BACKGROUND

Modern portable electronic devices have led to a demand for portable electrical power and chemical batteries, which may be performance bottlenecks for such devices. Wireless products, such as smart phones, portable gaming devices, and computer laptops, in particular, have a great demand for sustained power. Batteries can provide sustained power, but they typically provide sustained power for only a few hours and must be recharged periodically.

The current method of recharging these products is to plug them into an external energy grid and to utilize energy derived from burning fossil fuels. This method has many drawbacks. Not only does the burning of fossil fuels emit carbon, which leads to environmental damage, but the method of energy generation is not sustainable due to the limited amount of fossil fuels. Moreover, this energy source is not always readily available to the consumer, and requires the consumer to be near an electrical outlet to recharge their device.

Alternative solutions of providing low-carbon-emission, mobile, and on-demand power also have their drawbacks. Conventional (non-rechargeable) batteries are mobile, can provide energy on-demand and do not have a carbon-emitting energy source, but generally do not have the energy density required to power long-term operation (requiring constant replacement) and suffer from waste and disposal issues. Additionally, conventional batteries are transported from factories to distribution sites via carbon-emitting trucks, contributing to their environmental footprint. High energy density solutions, such as lithium ion batteries, can provide mobile, on-demand power for short periods of time, but have a large environmental impact due to their need to be recharged from an electricity grid. Fuel cell based solutions can also provide mobile, on-demand power, but typically require energy-intensive processes to create hydrogen, which lead to a large environmental footprint if conventional energy sources are used in these processes. Additionally, fuel cell solutions suffer from transportation issues. For example, direct hydrogen storage (e.g. compressed gas) requires heavy metal canisters for transportation, which decrease vehicular efficiency and increase vehicular emissions. Low energy density hydrogen carriers, on the other hand, require many more trips and larger loads (relative to pure hydrogen) to transport the same amount of energy, which also results in a large environmental footprint. The above solutions all create a large environmental footprint during some phase of their lifecycle, whether it be in energy generation, transportation, refueling, or waste. Renewable energy sources such as wind, wave, hydro and solar offer low carbon emission energy, but provide energy sporadically and are often located far away from the end-user.

Thus, there is a need in the consumer products field to create an improved method of generating and distributing on-demand energy to the consumer in a low-carbon-emitting manner.

### BRIEF DESCRIPTION OF THE FIGURES

FIG. 1 is a schematic representation of a preferred embodiment of the method for manufacturing and distributing hydrogen storage compositions.

FIG. 2 is a schematic representation of a preferred embodiment of the step of facilitating the use of the hydrogen storage composition to generate electricity.

FIG. 3 is a schematic representation of the steps of generating energy from a low-carbon-emitting source, using the generated energy to produce a hydrogen storage composition, transporting the hydrogen storage composition and a reagent to the consumer, facilitating the use of the hydrogen storage composition to generate electricity, and facilitating the return of reaction by-products to a regeneration facility.

FIG. 4 is a schematic representation of a preferred embodiment of a hydrogen generator.

FIG. 5 is a schematic representation of a preferred controller for fuel cell operation.

FIG. 6 is a schematic representation of a preferred embodiment of the transportation apparatus.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

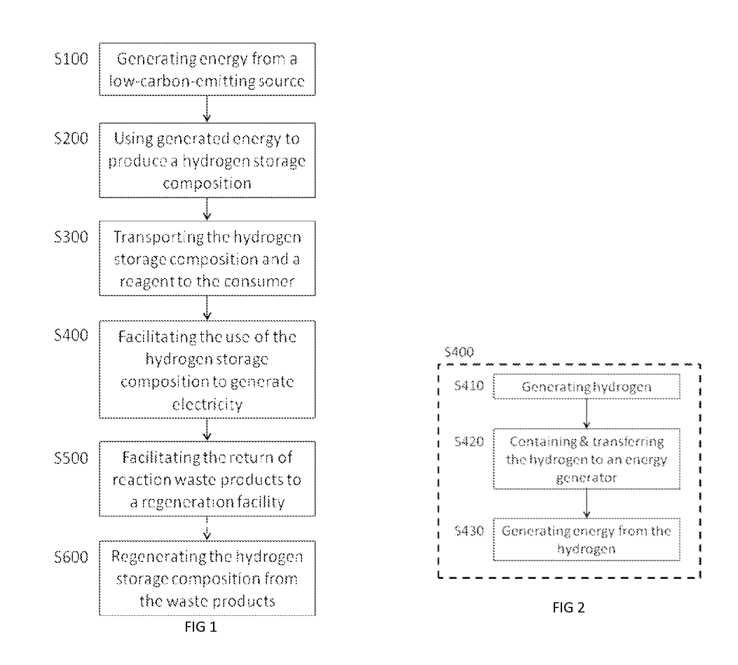

As shown in FIG. 1, the method for manufacturing and distributing hydrogen storage compositions includes the steps of: generating energy from a low-carbon-emitting source S100, using the generated energy to produce a hydrogen storage composition S200, transporting the hydrogen storage composition and a reagent to the consumer S300, facilitating the use of the hydrogen storage composition to generate electricity S400, and facilitating the return of reaction by-products to a regeneration facility S500. This method is preferably used to distribute an on-demand power source to the consumer. One potential advantage of this distribution method includes low carbon emissions. By placing the energy carrier (hydrogen storage composition) and energy generation (conversion of the carrier to H₂ to electricity) in the reach of the consumer, unexpected savings in environmental impact, as measured by carbon emission, can be achieved. This may be potentially due to several factors. By utilizing a hydrogen storage composition and storing energy in a chemical form, sporadic but low carbon emission energy sources such as renewable energy (e.g. wind, solar, hydro, or wave power) may be used. Additionally, by transporting a chemical hydrogen storage composition, storage issues such as energy-intensive cooling or utilizing heavy metal containers (needed for compressed hydrogen or metal hydride hydrogen storage solutions) may be eliminated, which translates to savings in vehicular efficiency and lower emissions. Further, by allowing the consumer to generate hydrogen only when needed (e.g. according to the consumer's portable electronic device electricity demand) the total amount of hydrogen in gaseous form present in the power system is minimized, thus increasing system stability and decreasing system volatility. This method enables the consumer to control when they generate energy, making the power supply entirely “on-demand.”

The step of generating energy from a low-carbon-emitting source S100 functions to provide the energy necessary to generate hydrogen-storage compositions while minimizing environmental impact, as measured by the amount of carbon emission. A low-carbon-emitting source of energy is preferably a wind turbine, but may alternatively be a photovoltaic system, geothermal system, wave energy system, any renewable energy source or combination thereof, or a nuclear power system.

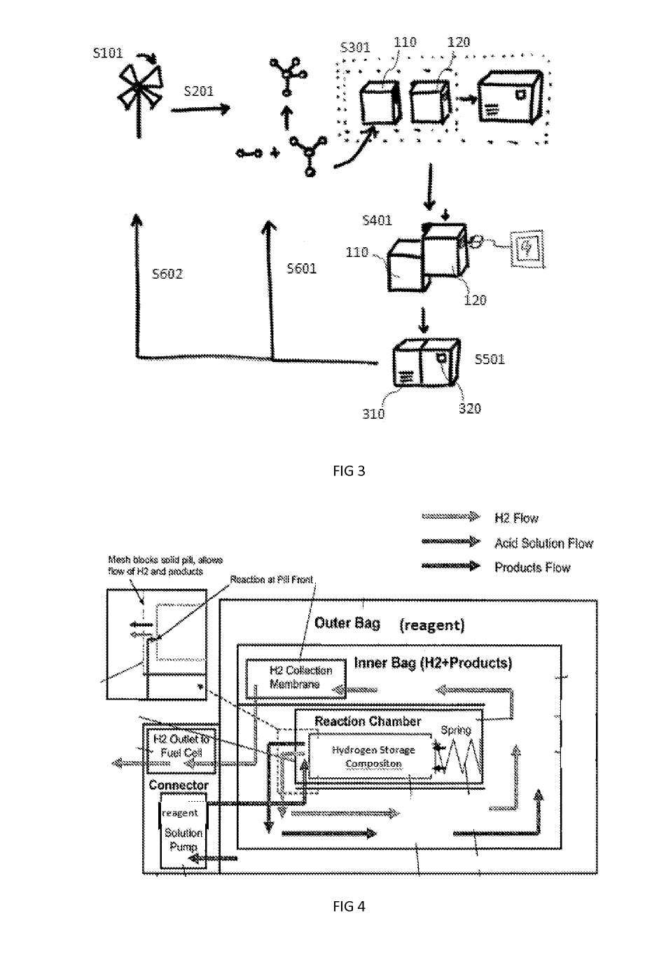

The step of using the generated energy to generate a hydrogen storage composition S200 functions to store hydrogen (and subsequently, the energy contained in hydrogen) for subsequent use. The step is preferably accomplished by applying energy to store hydrogen as a metal hydride, such as LiH, NaAlH₄, LaNi₅H₆, TiFeH₂, lithium aluminum hydride (LiAlH₄), lithium deuteride (LiD), sodium borohydride (NaBH₄), ammonia borane, or aluminum hydride (AlH₃), but hydrogen may alternatively be stored in any chemical composition that does not emit carbon dioxide upon release of hydrogen. The hydrogen storage composition preferably forms hydrogen in an exothermic reaction, but may utilize an endothermic reaction as well. The generation of the hydrogen storage composition may be sporadic and vary at the same frequency as the generation of energy, but may also be constantly generated as well. The generation of the hydrogen storage composition is preferably located at the site of energy generation, but may alternatively be located in a separate site. The energy used to generate the hydrogen storage composition may be directly transferred from the source to the composition (e.g., using geothermal heat to directly react NaBO₂ with H₂ to give the hydrogen storage composition NaBH₄), may be indirectly transferred from the source to the composition (e.g., using a wind turbine connected to a reaction chamber to transfer the energy from wind to the hydrogen storage composition S101, as shown in FIG. 3), or may be stored and later transferred to the hydrogen storage composition (e.g., as using a photovoltaic cell to gather energy from the sun, storing the energy in a battery, then transmitting the energy to a filling facility to generate the hydrogen storage composition).

The step of transporting the hydrogen storage composition and a reagent to the consumer S300 functions to place the stored energy (the hydrogen storage composition) and a means of accessing the energy (a reagent) within the reach of the consumer. Transporting the hydrogen storage composition preferably includes delivering the hydrogen storage composition and reagent directly to the customer, but may also include employing a courier, placing the hydrogen storage composition and reagent in the federal mail, or any other means of facilitating the transfer of the hydrogen storage composition and reagent to the consumer. The hydrogen storage composition and reagent are preferably transported together S301 (shown in FIG. 3), but may also be transported separately using separate methods. The transportation method preferably delivers the hydrogen storage composition and reagent directly to the consumer (e.g. via mail or car), but may alternatively deliver the composition and reagent to a distributor such that the consumer purchases the composition and reagent at the distributor. This latter embodiment may involve bulk transportation of the hydrogen storage composition and reagent to the distributor, who then separates and distributes the hydrogen storage composition and reagent in smaller portions to the customers, or may involve transportation of many consumer-sized portions of the hydrogen storage composition and reagent to the distributor, who then sells the consumer-sized portions. Additionally, the transportation mode is preferably a low-carbon emitting mode of transportation, such as a hybrid vehicle or electric vehicle, but may also be an established and widespread distribution method, such as the federal mail system. However, the transportation mode may be any low-carbon emitting mode of transporting and distributing the hydrogen storage composition and reagent to consumers.

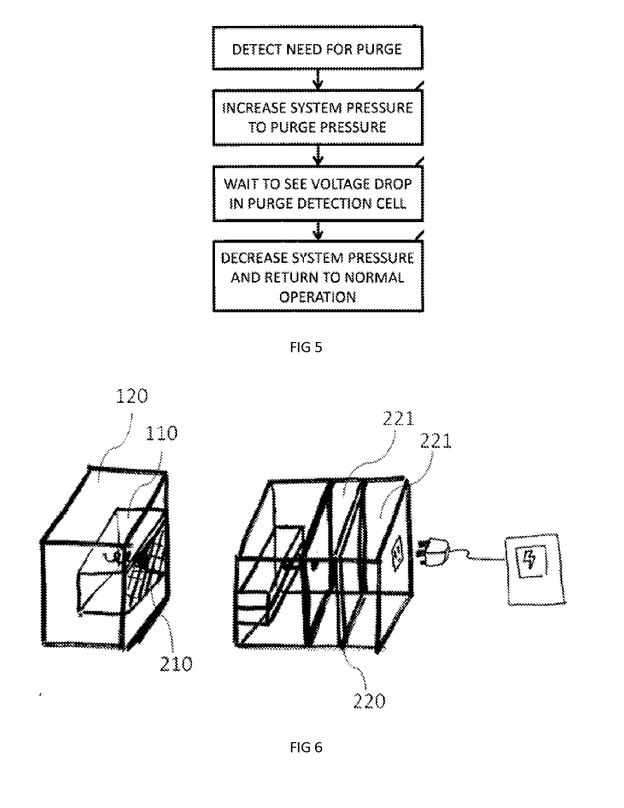

The apparatus used for transportation preferably includes separate storage containers, one for the hydrogen storage composition and one for the reagent, but may also be a single container or multiple containers. The apparatus used for transportation also preferably includes a hydrogen generation mechanism 210 in one of the storage containers, as shown in FIG. 6, but may include no hydrogen generation mechanisms, may include a fuel cell with a controller for energy generation, or may include any combination thereof. The hydrogen generation mechanisms is preferably the device as described in U.S. application Ser. No. 12/501,675 entitled “Hydrogen Generator”, which is incorporated in its entirety by this reference. The hydrogen fuel cells 221 and controllers for their operation are preferably the devices as described in U.S. application Ser. No. 12/583,925 entitled “Controller for Fuel Cell Operation”, which is incorporated in its entirety by this reference. The hydrogen storage composition being transported may be any of the previously mentioned compositions for hydrogen storage. The reagent being transported is preferably an acid solution, but may alternatively be water, alcohol solutions, or any other reagent that produces hydrogen upon direct or indirect reaction with the hydrogen storage composition.

The step of facilitating the use of the hydrogen storage composition to generate electricity S400 functions to allow the consumer to generate electricity on-demand. As shown in FIG. 2, this step preferably comprises of three steps: generating hydrogen S410, containing and transferring the hydrogen to an energy generator S420, and generating energy from the hydrogen S430. Hydrogen is preferably generated with a hydrogen generation mechanism 210, such as the one described in the '675 reference, shown in FIG. 4. However, hydrogen may be generated in any manner from the hydrogen storage composition and reagent, such as by mixing the hydrogen storage composition and reagent in a beaker. The method of triggering the hydrogen generation preferably includes the detection of a plug being inserted into the energy generator 220, but may also include a button being depressed, a coupling of the hydrogen storage composition- and reagent-containing packages together, or a signal from the fuel cell controller, as described in the '925 reference. The hydrogen produced is preferably directly delivered into the energy generator 220 as it is being produced, but may alternately be contained in the manner described by the '675 reference then transferred later to the energy generator 220, or be contained in a balloon wherein the entire balloon is transferred to the energy generator 220 and then perforated. The energy generator 220 that the hydrogen is transferred to is preferably a series of fuel cells 221 with a controller such as the one described in the '925 reference (shown in FIGS. 5 and 6), but may alternatively be a catalytic membrane, a single fuel cell with no controller, or any number of fuel cells 221 with any number of controllers. The energy generator 220 is preferably integrated with the hydrogen generator 210 when in use, but may be directly connected to the hydrogen generator 210 or entirely separate from the hydrogen generator 210 while in use. The method of triggering energy generation preferably includes detection of a plug being inserted into the energy generator 220, but may also include the flipping of a switch, the detection of low voltage in the fuel cell as described in the '925 reference, or insertion of the energy generator into a portable electronic device. The rate of hydrogen production preferably matches the rate of energy consumption, but may be faster than the rate of energy consumption (e.g. storing hydrogen in the fuel cell) or slower than the rate of energy consumption (e.g. not generating hydrogen while generating electricity, providing electricity from a hybridizing battery).

As shown in FIG. 6, an embodiment of this step S400 includes a hydrogen generator 210 coupled to a series of fuel cells 221 controlled by a controller, wherein the hydrogen generator 210 is contained within the hydrogen storage composition container 110, and the fuel cells 221 and controller are contained within a separate unit 220. The reagent container 120 may clip into the hydrogen storage composition container 110, which, in turn, may clip into the fuel cell unit 220. In this embodiment, the detection of a plug being inserted into the fuel cell 221 prompts the controller to trigger electricity generation or to trigger hydrogen generation, depending on the amount of hydrogen accessible by the fuel cell. In another embodiment, the hydrogen storage composition container no, reagent container 120, hydrogen generator 210 and energy generator 220 are separate entities. Hydrogen is generated when desired by plugging the hydrogen storage composition container 110 and the reagent container 120 into the hydrogen generator 210, which proceeds to generate hydrogen when both containers are detected as present. The hydrogen is then stored in the hydrogen generator 210 until it is desirable to transfer the hydrogen to the energy generator 220, which can be accomplished by piping the hydrogen into the energy generator 220. The hydrogen is then stored in the energy generator 220 until energy is desired. This step S400 allows the customer to generate electricity “on-demand” because the energy (and the hydrogen necessary to generate the energy) is not produced until the customer actively triggers the production, whether the consumer action be plugging a device into the energy generator 220, combining the hydrogen storage compound container and the reagent container 120, or flipping a switch.

The step of facilitating the return of reaction by-products to a regeneration facility S500 functions to regain reusable materials (such as reaction by-products and storage containers) as well as to decrease the environmental impact of utilizing fuel cells 221 by minimizing and properly disposing of chemical waste. Facilitating the return of by-products preferably includes providing a return mailing label 310 and postage 320 on a by-product (as shown in FIG. 3), but may also include a courier who picks up the by-products or a drop-off facility that accepts the by-products. By-products preferably include the by-products of the reaction, but may also include the storage containers of the reactants, the hydrogen generation apparatus, the energy generation apparatus or any combination thereof. The regeneration facility is preferably a factory that produces the hydrogen storage composition, but may alternatively be a supplier of any component required in this method, a renewable energy plant, or any factory or manufacturer that can utilize the by-products in their manufacturing processes.

The method of the preferred embodiments may also include the additional step of regenerating the hydrogen storage composition from the by-products S600. Step S600 functions to minimize the impact of chemical waste on the environment by reusing the by-products generated during hydrogen and energy generation. Regeneration of the hydrogen storage composition is preferably accomplished by annealing a by-product of hydrogen production reaction (such as NaBO₂ from the NaBH₄ hydrogen production reaction) with MgH₂ or Mg₂Si, but may be accomplished by reduction by sodium hydride, by electrolysis, or by any other processes that generate hydrogen storage compositions from by-products of the hydrogen-generating process.

As a person skilled in the art will recognize from the previous detailed description and from the figures and claims, modifications and changes can be made to the preferred embodiments of the invention without departing from the scope of this invention defined in the following claims.

1. A low-carbon-emission method of manufacturing and distributing a power source to a consumer, comprising the steps of:
a) generating energy from a low-carbon-emitting source;
b) producing a hydrogen storage composition using the generated energy;
c) transporting the hydrogen storage composition and a reagent to the consumer;
d) facilitating the use of the hydrogen storage composition to generate electricity; and
e) facilitating the return of reaction by-products to a regeneration facility.

2. The method of claim 1 wherein the low-carbon-emitting source is selected from a group consisting of: wind, wave, hydro, solar, and geothermal energy.

3. The method of claim 1 wherein step b) further comprises the step of using a reaction, wherein the reaction does not form carbon dioxide as a reaction product.

4. The method of claim 1 wherein the hydrogen storage composition is a metal hydride.

5. The method of claim 4 wherein the hydrogen storage composition is sodium borohydride.

6. The method of claim 5 wherein the reagent is an acid with a pH of 2 or less.

7. The method of claim 1 wherein the hydrogen storage composition is sodium silicide.

8. The method of claim 1 wherein step c) further comprises the steps of:
shipping the hydrogen storage composition and reagent to a distributor; and
providing distribution instructions.

9. The method of claim 1 wherein step c) further comprises the steps of:
providing a container for the hydrogen storage composition;
providing a mailing address panel on the container;
providing postage on the container; and
placing the container in a mailbox.

10. The method of claim 1 wherein step d) further comprises the step of providing a hydrogen generator.

11. The method of claim 10 wherein the hydrogen generator includes:
a reaction chamber that receives the hydrogen storage composition, the chamber having a reaction product separator impermeable to the hydrogen storage composition and a biasing mechanism that biases the reactant products against the separator;
a liquid reactant dispenser that stores a liquid reactant and fluidly coupled to the reaction chamber, such that dispensed liquid reactant reacts with the hydrogen storage composition in the reaction chamber to produce hydrogen gas and a waste product that are substantially permeable through the separator; and
a product collector coupled to the reaction chamber that collects the hydrogen gas and waste product that have passed through the separator.

12. The method of claim 10 wherein step d) further comprises the step of providing an energy generator.

13. The method of claim 12 wherein the energy generator is a fuel cell.

14. The method of claim 13 wherein the fuel cell is controlled by a controller that includes the following control loops:
a first control loop, wherein said first control loop is disposed to adjust a fuel cell current to regulate a hydrogen output pressure from the fuel cell to a pressure target value; and
a second control loop, wherein said second control loop is disposed to adjust a hydrogen flow rate from a hydrogen generator to match a fuel cell power output to a power target value.

15. The method of claim 13 wherein step d) further comprises the steps of:
containing the hydrogen storage composition in a hydrogen storage composition container;
containing the reagent in a reagent container;
coupling the hydrogen storage composition container, reagent container, hydrogen generator, and energy generator together, wherein the containers are capable of fluid communication with adjacent containers; and
triggering energy generation by plugging in a portable electronic device.

16. The method of claim 1 wherein step d) further comprises the step of providing an energy generator.

17. The method of claim 16 wherein the energy generator is a hydrogen fuel cell.

18. The method of claim 17 wherein step d) further comprises the step of instructing the consumer to insert the hydrogen storage composition, reagent, and energy generator into a portable electronic device, wherein latent heat from operation of the device triggers hydrogen generation.

19. The method of claim 1 wherein step e) further comprises the steps of:
providing a mailing address; and
providing postage.

20. The method of claim 1 wherein the regeneration facility is an energy plant.

21. The method of claim 1 further comprising the step of regenerating the hydrogen storage composition from the by-products.

22. The method of claim 21 wherein the process of regenerating the hydrogen storage composition is the same as the process used in step b).

23. The method of claim 1 wherein the customer is a user of a portable electronic device.

24. A low-carbon-emission method of manufacturing and distributing a power source, comprising the steps of:
producing a hydrogen storage composition by using energy generated from a low-carbon-emitting energy source;
facilitating the transportation of the hydrogen storage composition, a reagent, a hydrogen generator and an energy generator to a portable electronic device user; and
facilitating the return of reaction by-products to a regeneration facility.

25. The method of claim 24 wherein the low-carbon-emitting energy source is selected from a group consisting of: wind, wave, water, solar, and geothermal energy.

26. The method of claim 24 wherein the hydrogen generator includes:
a reaction chamber that receives the hydrogen storage composition, the chamber having a reaction product separator impermeable to the hydrogen storage composition and a biasing mechanism that biases the reactant products against the separator;
a liquid reactant dispenser that stores a liquid reactant and fluidly coupled to the reaction chamber, such that dispensed liquid reactant reacts with the hydrogen storage composition in the reaction chamber to produce hydrogen gas and a waste product that are substantially permeable through the separator; and
a product collector coupled to the reaction chamber that collects the hydrogen gas and waste product that have passed through the separator.

27. The method of claim 24 wherein the energy generator includes a series of fuel cells controlled by a controller.

28. The method of claim 24 wherein the by-products include: reaction by-products, the hydrogen generator, and the energy generator.

29. The method of claim 24 wherein the hydrogen storage composition is sodium borohydride.

30. The method of claim 29 wherein the reagent is an acid solution with a pH of 2 or less.

31. A low-carbon-emission method of manufacturing and distributing a power source, comprising the steps of:
using energy generated from a wind turbine to produce sodium borohydride;
placing in the mail:
i. the sodium borohydride
ii. acid
iii. a hydrogen generator including:
a reaction chamber for receiving a solid reactant, the chamber having a reaction product separator impermeable to the solid reactant and a biasing means for biasing reactant products against the separator;
a liquid reactant dispenser for storing a liquid reactant and fluidly coupled to the reaction chamber, such that dispensed liquid reactant reacts with the solid reactant in the reaction chamber to produce hydrogen gas and a waste product that are substantially permeable through the separator; and
a product collector coupled to the reaction chamber for collecting hydrogen gas and waste product that have passed through the separator;
iv. a series of fuel cells;
v. a fuel cell controller, comprising:
a first control loop, wherein said first control loop is disposed to adjust a fuel cell current to regulate a hydrogen output pressure from said fuel cell to a pressure target value; and
a second control loop, wherein said second control loop is disposed to adjust a hydrogen flow rate from a hydrogen generator to match a fuel cell power output to a power target value; and
i. instructions for energy generation; and
facilitating the return of reaction by-products, the hydrogen generator, the fuel cells and the fuel cell controller to a power plant.
